(19) United States
(12) Patent Application Publication
(10) Pub. No.: US 2026/0202302 A1
(43) Pub. Date: Jul. 16, 2026

(54) DEVICE AND METHOD FOR TESTING THE FULL-PROCESS NEGATIVE CARBON CONTENT OF CARBON DIOXIDE SEQUESTRATION IN FILLING BODIES

(71) Applicant: China University of Mining and Technology, Xuzhou (CN)

(72) Inventors: Baiyi Li, Xuzhou (CN); Zejun Li, Xuzhou (CN); Yuming Guo, Xuzhou (CN); Jixiong Zhang, Xuzhou (CN); Nan Zhou, Xuzhou (CN); Dan Ma, Xuzhou (CN); Junmeng Li, Xuzhou (CN); Feng Ju, Xuzhou (CN)

(21) Appl. No.: 19/433,395

(22) Filed: Dec. 26, 2025

(30) Foreign Application Priority Data
Jan. 16, 2025 (CN) 202510069292.2

(51) Int. Cl. G01N 15/08; G01N 3/08

(52) U.S. Cl. CPC G01N 15/0826; G01N 3/08

(57) ABSTRACT

A device and method for testing the full-process negative carbon content of carbon dioxide sequestration in filling bodies, the device comprises: a filling body sequestration and carbonation subsystem, a high-pressure gas injection subsystem, a triaxial stress loading subsystem, a constant temperature control subsystem, a data acquisition subsystem and a vacuum pumping subsystem. The stress loading subsystem and constant temperature control subsystem are used to simulate real filling and sequestration conditions. Helium and carbon dioxide are injected respectively via high-pressure gas injection subsystem, serving to measure free space volume of reactor, as well as carbon sequestration capacity and permeability of filling bodies. The invention solves the problem that sequestration capacity and efficiency are difficult to accurately determine in existing simulation tests of carbon dioxide sequestration in filling bodies, realizing full-process simulation test of carbon dioxide sequestration in filling bodies under triaxial stress loading, temperature control, and gas injection pressure control.

### TECHNICAL FIELD

The invention relates to the technical field of underground carbon dioxide sequestration, and specifically to a device and method for testing the full-process negative carbon content of carbon dioxide sequestration in filling bodies.

### BACKGROUND ART

The production and combustion of fossil energy such as coal generate a large amount of carbon dioxide and polluting gases, which are one of the main sources of carbon emissions. In addition, the production of coal-based solid wastes such as coal gangue and fly ash generated during coal mining and utilization is enormous, and improper disposal will further cause ecological and environmental pollution. How to realize large-scale disposal of coal-based solid wastes while sequestering carbon dioxide is a key problem for the low-carbon and green development of coal.

During the flow and migration of carbon dioxide in the filling body, it continuously contacts the pore surfaces of the filling body and undergoes physical and chemical reactions such as adsorption, dissolution, and mineralization, enabling stable sequestration of carbon dioxide inside the filling body. Clarifying the sequestration capacity and efficiency of the filling body is crucial for the on-site application of the carbon dioxide sequestration technology using filling bodies. The in-situ stress environment of the mine and the physical property parameters of the filling body can directly affect the pore permeability characteristics of the filling body, thereby leading to changes in the sequestration capacity and efficiency of the filling body. Therefore, the stress state of the filling body must be considered in the evaluation of carbon dioxide sequestration capacity and stability of the filling body. In addition, the injection pressure of carbon dioxide and the formation temperature will cause changes in the thermodynamic properties of carbon dioxide, which in turn affect the sequestration capacity and efficiency of the filling body. Therefore, it is necessary to study the sequestration law of filling bodies under triaxial stress conditions. However, existing devices only consider the adsorption of coal and rock, cannot realize long-term simulation tests of carbon dioxide sequestration in filling bodies under triaxial stress conditions, and cannot accurately calculate the full-process negative carbon content and permeability of carbon dioxide sequestration in filling bodies.

### SUMMARY OF THE INVENTION

Technical problems to be solved: aiming at the problem in the prior art that the sequestration capacity and efficiency are difficult to accurately and long-term determine in coal and rock carbon dioxide sequestration simulation tests, the invention provides a device and method for testing the full-process negative carbon content of carbon dioxide sequestration in filling bodies. The device adopts a stress loading subsystem and a constant temperature control subsystem to simulate the mine filling and sequestration environment, sequentially injects helium and carbon dioxide through a high-pressure gas injection subsystem, and measures the free space volume of the reactor, as well as the negative carbon content and permeability of the filling body. The method of the invention can accurately monitor the negative carbon content and permeability during the entire process of carbon dioxide sequestration in the filling body, obtain the variation law of the negative carbon content of the filling body with time, and is used to analyze the mechanism of carbon dioxide sequestration by filling.

Technical solution: one object of the invention is to provide a device for testing the full-process negative carbon content of carbon dioxide sequestration in filling bodies, the testing device comprising: a filling body sequestration and carbonation subsystem, a high-pressure gas injection subsystem, a triaxial stress loading subsystem, a constant temperature control subsystem, a vacuum pumping subsystem, and a data acquisition subsystem.

The main structure of the filling body sequestration and carbonation subsystem is a reactor, the reactor is a horizontal triaxial core holder wherein a rock sample is replaced with a filling body samples, it includes a confining pressure structure arranged around the filling body sample, an axial pressure structure arranged at one end of the filling body sample, and a horizontal air inlet hole and an air outlet hole arranged at both ends of the filling body sample; the confining pressure structure is provided with a confining pressure inlet, and the axial pressure structure is provided with an axial pressure inlet;
the high-pressure gas injection subsystem includes a standard chamber, a CO₂ boosting pipeline and a He boosting pipeline; the CO₂ boosting pipeline includes a high-pressure CO₂ storage tank, one end of the standard chamber is respectively connected to the high-pressure CO₂ storage tank and the high-pressure He storage tank through pipelines, and an other end thereof is connected to an air inlet hole of the reactor; an outlet of the high-pressure CO₂ storage tank is provided with a valve c and a pressure sensor a, an outlet of the high-pressure He storage tank is provided with a valve d and a pressure sensor b, an outlet of the standard chamber is provided with a valve e and a pressure sensor c, and the air inlet hole of the reactor is provided with a valve f and a pressure sensor d;
the triaxial stress loading subsystem includes an axial pressure pump and a confining pressure pump, and the axial pressure pump and confining pressure pump are respectively connected to the axial pressure inlet and the confining pressure inlet through pipelines;
the constant temperature control subsystem includes a constant temperature water bath and a temperature sensor connected thereto, the constant temperature water bath is arranged outside the reactor and the standard chamber for adjusting the temperature;
the vacuum pumping subsystem includes a vacuum pump connected to the air outlet hole of the reactor, an inlet of the vacuum pump is provided with a pressure sensor f, and an air outlet of the reactor is sequentially provided with a pressure sensor e and a valve g;
the data acquisition subsystem includes a data acquisition unit and a data analysis unit; the data acquisition unit includes the pressure sensor a, pressure sensor b, pressure sensor c, pressure sensor d, pressure sensor e, pressure sensor f, and temperature sensor; the data analysis unit is a controller and a display, an input end of the controller is respectively electrically connected to the pressure sensor a, pressure sensor b, pressure sensor c, pressure sensor d, pressure sensor e, pressure sensor f, and temperature sensor, and an output end of the controller is electrically connected to the display.

Preferably, the device for testing the full-process negative carbon content of carbon dioxide sequestration in filling bodies further includes a seepage monitoring subsystem, which includes a condenser, a saturated sodium bicarbonate solution storage tank, and an electronic balance sequentially connected through pipelines; an air inlet end of the condenser is connected to the air outlet hole of the reactor through a pipeline, and an air inlet end of the condenser is provided with a valve j and a gas flow sensor; the electronic balance is used to weigh the mass of the solution discharged from the saturated sodium bicarbonate solution storage tank; the gas flow sensor and the electronic balance are respectively electrically connected to an input end of the controller.

Preferably, the CO₂ boosting pipeline also includes a CO₂ gas cylinder, a booster pump a, and an air compressor a; the CO₂ gas cylinder, a valve a, the booster pump a, the pressure sensor a, the valve c and the high-pressure CO₂ storage tank are sequentially connected through pipelines; the pipeline between the pressure sensor a and the valve c is connected to the standard chamber, and the air compressor a is connected to the booster pump a to provide gas pressure; the He boosting pipeline also includes a He gas cylinder, a booster pump b, and an air compressor b; the He gas cylinder, valve b, booster pump b, pressure sensor b, valve d and high-pressure He storage tank are sequentially connected through pipelines; the pipeline between the pressure sensor b and the valve d is connected to the standard chamber, and the air compressor b is connected to the booster pump b to provide gas pressure.

Preferably, the reactor includes a reactor cylinder, a piston, a plug, a first compression cap, a second compression cap, a first fixed collar, a second fixed collar, and a rubber sleeve; the rubber sleeve is axially arranged inside the reactor cylinder, the rubber sleeve has an axially through cavity for accommodating the filling body sample to be tested; the first compression cap and the second compression cap are respectively embedded around the piston and the plug and arranged at both ends of the reactor cylinder; the first fixed collar and the second fixed collar are respectively arranged at both ends of the rubber sleeve and respectively abut against inner ends of the first compression cap and the second compression cap; the piston passes through the first compression cap and is arranged in an internal cavity of the first fixed collar, and can move left and right in the cavity; the plug passes through the second compression cap and is arranged in an internal cavity of the second fixed collar, and an inner end of the plug abuts against a side end of the filling body sample; axial centers of the piston and the plug are provided with holes to form the horizontal air inlet hole and the air outlet hole for air inlet and outlet at both ends of the filling body sample; an outer wall of the rubber sleeve, an inner wall of the reactor cylinder, and the first fixed collar and the second fixed collar at both ends form a confining pressure chamber, and the confining pressure inlet is arranged on the reactor cylinder; the cavity formed by the piston, the first compression cap and the first fixed collar is an axial pressure chamber, and the axial pressure inlet is arranged on the first compression cap.

Preferably, the reactor also includes a bracket, which is arranged at a bottom of the reactor to support the reactor.

Preferably, the vacuum pumping subsystem also includes a buffer device arranged between pipelines connecting the pressure sensor f and the valve g; an inlet of the buffer device is provided with a valve h, one outlet is provided with a valve i, and an other outlet is connected to the pressure sensor f through a pipeline.

An other purpose of the invention is to provide a method for testing the full-process negative carbon content of carbon dioxide sequestration in filling bodies based on the above-mentioned device for testing the full-process negative carbon content of carbon dioxide sequestration in filling bodies, the steps are as follows:
step 1: put the filling body sample into the reactor and connect the device for testing the full-process negative carbon content of carbon dioxide sequestration in filling bodies;
step 2: close all valves, open valve d and valve e, inject He into the standard chamber, then open valve f to perform air tightness test of the device;
step 3: close all valves, open valve e, valve f, and valve g, open the vacuum pump to establish a vacuum in the device;
step 4: set the temperature of the constant temperature water bath, and apply axial pressure and confining pressure through the triaxial stress loading subsystem;
step 5: close all valves, open valve d and valve e, inject He into the standard chamber and close valve d; after the reading of pressure sensor c stabilizes at P_{S1}, open valve f; when the readings of pressure sensor c and pressure sensor d are the same and stabilize at P_{R2}, calculate the free space volume of the device, i.e., the pore volume V_{S} of the filling body in the reactor.

The calculation formula is as follows:

$${V}_{R} = ( \frac{{P}_{S 1} {Z}_{R 2}}{{P}_{R 2} {Z}_{S 1}} - 1 ) {V}_{S}$$

wherein, V_{R} is the volume of the standard chamber, cm³; V_{S} is the pore volume of the filling body in the reactor, cm³; P_{S1} is the initial He pressure in the standard chamber, MPa; P_{R2} is the stable He pressure in the reactor, MPa; Z_{S1} and Z_{R2} are compression factors of initial He in the standard chamber and stable He in the reactor, respectively, obtained by querying the REFPROP physical property database software developed by the National Institute of Standards and Technology;
step 6: close all valves, open valve e, valve f, and valve g, open the vacuum pump to establish a vacuum in the device; close valve f and valve g, open valve c, inject CO₂ into the standard chamber; close valve c, after the reading of pressure sensor c stabilizes at P_{S3}, open valve f; when the readings of pressure sensor c and pressure sensor d are the same and stabilize at P_{R4}, calculate the carbon sequestration capacity of the filling body. The formula is as follows:

$${P}_{S 3} {V}_{R} = {Z}_{S 3} {n}_{b 1} RT$$

$${P}_{R 4} ( {V}_{S} + {V}_{R} ) = {Z}_{R 4} {n}_{b 2} RT$$

$${n}_{b} = \frac{{n}_{b 1} - {n}_{b 2}}{M} = \frac{1}{MRT} ( \frac{{P}_{S 3} {V}_{R}}{{Z}_{S 3}} - \frac{{P}_{R 4} ( {V}_{S} + {V}_{R} )}{{Z}_{R 4}} )$$

Wherein, P_{S3} is the initial CO₂ pressure in the standard chamber, MPa; P_{R4} is the stable CO₂ pressure in the reactor, MPa; V_{R} is the volume of the standard chamber, cm³; V_{S} is the pore volume of the filling body in the reactor, cm³; Z_{S3} and Z_{R4} are the compression factors of initial CO₂ in the standard chamber and stable CO₂ in the reactor, respectively, obtained by querying the REFPROP physical property database software developed by the National Institute of Standards and Technology; n_{b} is the carbon sequestration capacity per unit mass of the filling body, mmol/g; n_{b1} and n_{b2} are the initial amount of CO₂ in the standard chamber and the amount of CO₂ in the standard chamber and reactor after the start of sequestration, respectively, mmol; M is the mass of the filling body, g; R is the universal gas constant, 8.31 J/(mol K); T is the temperature of the constant temperature water bath, K;
step 7: when the CO₂ injection time reaches the target number of days, close valve e and valve f, and calculate the free sequestration capacity of the filling body according to the reading P_{R5} of pressure sensor d. The calculation formula is as follows:

$${n}_{f} = \frac{{P}_{R 5} {V}_{S}}{{MRTZ}_{R 5}}$$

Wherein, n_{f} is the free sequestration capacity of the filling body, mmol/g; P_{R5} is the pressure in the reactor, MPa; V_{S} is the pore volume of the filling body in the reactor, cm³; Z_{R5} is the compression factor of CO₂ in the reactor, obtained by querying the compression factor charts of carbon dioxide at different temperatures and pressures; M is the mass of the filling body, g; R is the universal gas constant, 8.31 J/(mol K); T is the temperature of the constant temperature water bath, K.

Preferably, the method also includes a permeability test, and the specific steps are as follows:
step 1: put the filling body sample into the reactor and connect the device for testing the full-process negative carbon content of carbon dioxide sequestration in filling bodies;
step 2: close all valves, open valve d and valve e, inject He into the standard chamber, then open valve f to perform air tightness test of the device;
step 3: close all valves, open valve e and valve f, open the vacuum pump to establish a vacuum in the device;
step 4: set the temperature of the constant temperature water bath, and apply axial pressure and confining pressure through the triaxial stress loading subsystem;
step 5: close all valves, open valve d and valve e, inject He into the standard chamber, close valve d, after the reading of pressure sensor c stabilizes at P_{S1}, open valve f; when the readings of pressure sensor c and pressure sensor d are the same and stabilize at P_{R2}, calculate the free space volume of the device, i.e., the pore volume V_{S} of the filling body in the reactor. The calculation formula is as follows:

$${V}_{R} = ( \frac{{P}_{S 1} {Z}_{R 2}}{{P}_{R 2} {Z}_{S 1}} - 1 ) {V}_{S}$$

Wherein, V_{R} is the volume of the standard chamber, cm³; V_{S} is the pore volume of the filling body in the reactor, cm³; P_{S1} is the initial He pressure in the standard chamber, MPa; P_{R2} is the stable He pressure in the reactor, MPa; Z_{S1} and Z_{R2} are the compression factors of initial He in the standard chamber and stable He in the reactor, respectively, obtained by querying the REFPROP physical property database software developed by the National Institute of Standards and Technology;
step 6: close all valves, open valve e, valve f, and valve g, open the vacuum pump to establish a vacuum in the device; close valve f and valve g, open valve c; inject CO₂ into the standard chamber; close valve c, after the reading of pressure sensor c stabilizes at P_{R6}, open valve f and valve j and start timing. When the readings of pressure sensor c and pressure sensor d are the same and stabilize at P_{R7}, stop timing, record the seepage time as T, read the reading P_{R8} of pressure sensor e, monitor the readings of gas flow sensor and electronic balance, and calculate the CO₂ permeability in the filling body. The calculation formula is:

$$k = \frac{4 μ QL ( {P}_{R 6} - {P}_{R 7} )}{AT [ {( {P}_{R 6} - {P}_{R 7} )}^{2} - 4 {P}_{R 8}^{2} ]}$$

Wherein, k is the CO₂ permeability; is the dynamic viscosity of CO₂, Pa·s, Q is the total CO₂ seepage flow, m³; L is the length of the filling body, m; A is the cross-sectional area of the port of the filling body, m²; T is the seepage time, s; P_{R6}, P_{R7} and P_{R8} are the initial pressure at the inlet end of the reactor, the final pressure at the inlet end of the reactor, and the final pressure at the outlet end of the reactor, respectively, MPa.

Preferably, when the seepage flow is less than or equal to 0.001 m³/min, the gas flow sensor is used to calculate the total CO₂ seepage flow Q; when the seepage flow is greater than 0.001 m³/min, the water displacement method is used to calculate the total CO₂ seepage flow Q through the electronic balance.

Beneficial effects: permeability and carbon sequestration capacity are two key parameters of the carbon dioxide sequestration technology by filling, which can characterize the sequestration capacity of the filling body and the flow characteristics of CO₂, and are important indicators for evaluating the effect of carbon dioxide sequestration by filling. However, in the prior art, most carbon sequestration capacity tests are applied to coal and rock samples, and only consider mineralization or adsorption carbon sequestration capacity independently, without comprehensively considering the overall carbon sequestration capacity of the sample under various CO₂ sequestration effects such as mineralization, adsorption, dissolution, and free sequestration, nor considering the influence of CO₂ injection time on the carbon sequestration capacity of the sample. Therefore, the invention provides a device and method for testing the full-process negative carbon content of carbon dioxide sequestration in filling bodies. By using a stress loading subsystem and a constant temperature control subsystem to simulate real filling and sequestration conditions, and sequentially injecting helium and carbon dioxide through a high-pressure gas injection subsystem, the free space volume of the reactor, as well as the negative carbon content and permeability of the filling body are measured. The invention can accurately, in real-time, and quickly monitor the negative carbon content and permeability during the entire process of carbon dioxide sequestration in the filling body, ensuring the reliability and accuracy of test data.

### BRIEF DESCRIPTION OF ACCOMPANY DRAWINGS

FIG. 1 is a schematic structural diagram of a device for testing the full-process negative carbon content of carbon dioxide sequestration in filling bodies according to the invention;

FIG. 2 is a schematic structural diagram of the reactor of the invention;

FIG. 3 is a schematic diagram of the data acquisition unit of the invention;

The numerals in the figures represent the following: 1. CO₂ gas cylinder; 2. He gas cylinder; 3. valve a; 4. valve b; 5. booster pump a; 6. air compressor a; 7. air compressor b; 8. booster pump b; 9. pressure sensor a; 10. pressure sensor b; 11. valve c; 12. valve d; 13. high-pressure CO₂ storage tank; 14. high-pressure He storage tank; 15. standard chamber; 16. valve e; 17. pressure sensor c; 18. valve f, 19. pressure sensor d; 20. reactor; 21. pressure sensor e; 22. valve g; 23. valve h; 24. buffer device; 25. valve i; 26. pressure sensor f, 27. vacuum pump; 28. valve j; 29. gas flow sensor; 30. condenser; 31. saturated sodium bicarbonate solution storage tank; 32. electronic balance; 33. axial pressure pump; 34. confining pressure pump; 35. bracket; 36. temperature sensor; 37. constant temperature water bath; 38. data analysis unit; 39. data acquisition unit; 40. data acquisition subsystem; 41. reactor cylinder; 42. piston; 43. plug; 44. first compression cap; 45. second compression cap; 46. first fixed collar; 47. second fixed collar; 48. filling body sample; 49. rubber sleeve; 50. confining pressure inlet; 51. confining pressure chamber; 52. axial pressure inlet; 53. axial pressure chamber; 54. air inlet hole; 55. air outlet hole.

### SPECIFIC EMBODIMENT OF THE INVENTION

In order to make the objectives, technical solutions and advantages of the invention clearer, the invention will be further described in detail below with reference to the accompanying drawings and embodiments. It should be understood that the specific embodiments described herein are only for explaining the invention and are not intended to limit the invention.

### Embodiment

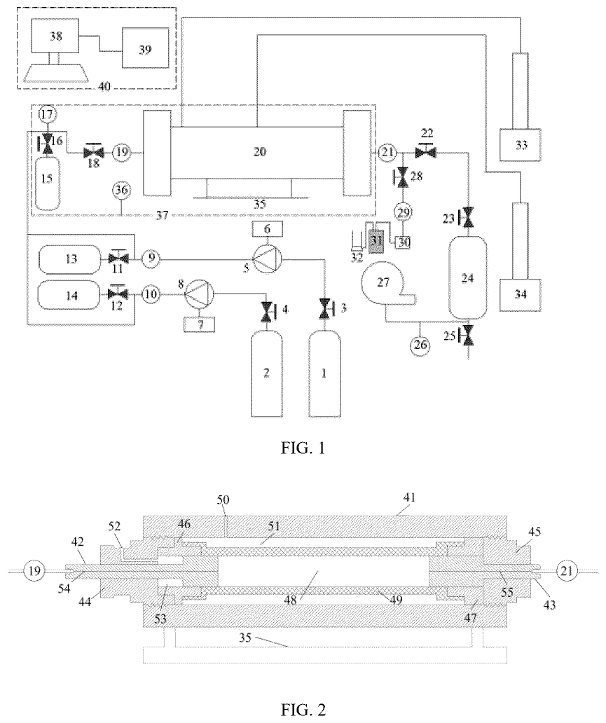

As shown in FIG. 1, a device for testing the full-process negative carbon content of carbon dioxide sequestration in filling bodies provided by an embodiment of the invention includes: a filling body sequestration and carbonation subsystem, a high-pressure gas injection subsystem, a triaxial stress loading subsystem, a constant temperature control subsystem, a vacuum pumping subsystem, a data acquisition subsystem 40, and a seepage monitoring subsystem.

The main structure of the filling body sequestration and carbonation subsystem is a reactor 20. The reactor 20 is a horizontal triaxial core holder, wherein the core is replaced with a filling body sample 48 (in this embodiment, the filling body sample 48 is a cylinder with a diameter of 50 mm and a height of 100 mm); it includes a confining pressure structure arranged around the filling body sample 48, an axial pressure structure arranged at one end of the filling body sample 48, and a horizontal air inlet hole 54 and an air outlet hole 55 arranged at both ends of the filling body sample 48; the confining pressure structure is provided with a confining pressure inlet 50, and the axial pressure structure is provided with an axial pressure inlet 52.

Further, as shown in FIG. 2, the reactor 20 includes a reactor cylinder 41, a piston 42, a plug 43, a first compression cap 44, a second compression cap 45, a first fixed collar 46, a second fixed collar 47, and a rubber sleeve 49; the rubber sleeve 49 is axially arranged inside the reactor cylinder 41, the rubber sleeve 49 has an axially through cavity for accommodating the filling body sample 48 to be tested; the first compression cap 44 and the second compression cap 45 are respectively embedded around the piston 42 and the plug 43 and arranged at both ends of the reactor cylinder 41; the first fixed collar 46 and the second fixed collar 47 are respectively arranged at both ends of the rubber sleeve 49 and respectively abut against inner ends of the first compression cap 44 and the second compression cap 45; the piston 42 passes through the first compression cap 44 and is arranged in an internal cavity of the first fixed collar 46, and can move left and right in the cavity; the plug 43 passes through the second compression cap 45 and is arranged in an internal cavity of the second fixed collar 47, and an inner end of the plug 43 abuts against a side end of the filling body sample 48; axial centers of the piston 42 and the plug 43 are provided with holes to form the horizontal air inlet hole 54 and the air outlet hole 55 for air inlet and outlet at both ends of the filling body sample 48; an outer wall of the rubber sleeve 49, an inner wall of the reactor cylinder 41, and the first fixed collar 46 and the second fixed collar 47 at both ends form a confining pressure chamber 51, and the confining pressure inlet 50 is arranged on the reactor cylinder 41; the cavity formed by the piston 42, the first compression cap 44 and the first fixed collar 46 is an axial pressure chamber 53, and the axial pressure inlet 52 is arranged on the first compression cap 44.

Further, the reactor 20 also includes a bracket 35, which is arranged at a bottom of the reactor 20 to support the reactor 20.

The high-pressure gas injection subsystem includes a standard chamber 15 (with a volume of 100 mL in this embodiment), a CO₂ boosting pipeline and a He boosting pipeline; the CO₂ boosting pipeline includes a high-pressure CO₂ storage tank 13, and the He boosting pipeline includes a high-pressure He storage tank 14; one end of the standard chamber 15 is respectively connected to the high-pressure CO₂ storage tank 13 and the high-pressure He storage tank 14 through pipelines, and an other end thereof is connected to the air inlet hole 54 of the reactor 20; an outlet of the high-pressure CO₂ storage tank 13 is provided with a valve c 11 and a pressure sensor a 9, an outlet of the high-pressure He storage tank 14 is provided with a valve d 12 and a pressure sensor b 10, an outlet of the standard chamber 15 is provided with a valve e 16 and a pressure sensor c 17, and the air inlet hole 54 of the reactor 20 is provided with a valve f 18 and a pressure sensor d 19.

Further, the CO₂ boosting pipeline also includes a CO₂ gas cylinder 1, a booster pump a 5, and an air compressor a 6. The CO₂ gas cylinder 1, a valve a 3, the booster pump a 5, the pressure sensor a 9, the valve c 11 and the high-pressure CO₂ storage tank 13 are sequentially connected through pipelines; the pipeline between the pressure sensor a 9 and the valve c 11 is connected to the standard chamber 15, and the air compressor a 6 is connected to the booster pump a 5 to provide gas pressure; the He boosting pipeline also includes a He gas cylinder 2, a booster pump b 8, and an air compressor b 7. The He gas cylinder 2, valve b 4, booster pump b 8, pressure sensor b 10, valve d 12 and high-pressure He storage tank 14 are sequentially connected through pipelines. The pipeline between the pressure sensor b 10 and the valve d 12 is connected to the standard chamber 15, and the air compressor b 7 is connected to the booster pump b 8 to provide gas pressure.

The triaxial stress loading subsystem includes an axial pressure pump 33 and a confining pressure pump 34, and the axial pressure pump 33 and confining pressure pump 34 are respectively connected to the axial pressure inlet 52 and the confining pressure inlet 50 through pipelines.

The constant temperature control subsystem includes a constant temperature water bath 37 and a temperature sensor 36 connected thereto, the constant temperature water bath 37 is arranged outside the reactor 20 and the standard chamber 15 for adjusting the temperature.

The vacuum pumping subsystem includes a vacuum pump 27 connected to the air outlet hole 55 of the reactor 20, an inlet of the vacuum pump is provided with a pressure sensor f 26, and an air outlet of the reactor 20 is sequentially provided with a pressure sensor e 21 and a valve g 22.

Further, the vacuum pumping subsystem also includes a buffer device 24 arranged between pipelines connecting the pressure sensor f 26 and the valve g 22; an inlet of the buffer device 24 is provided with a valve h 23, one outlet is provided with a valve i 25, and an other outlet is connected to the pressure sensor f 26 through a pipeline.

The seepage monitoring subsystem includes a condenser 30, a saturated sodium bicarbonate solution storage tank 31, and an electronic balance 32 sequentially connected through pipelines; an air inlet end of the condenser 30 is connected to the air outlet hole 55 of the reactor 20 through a pipeline, and an air inlet end of the condenser 30 is provided with a valve j 28 and a gas flow sensor 29; the electronic balance 32 is used to weigh the mass of the solution discharged from the saturated sodium bicarbonate solution storage tank 31. The gas flow sensor 29 and the electronic balance 32 are respectively electrically connected to an input end of the controller.

The data acquisition subsystem 40 includes a data acquisition unit 39 and a data analysis unit 38. The data acquisition unit 39 includes the pressure sensor a 9, pressure sensor b 10, pressure sensor c 17, pressure sensor d 19, pressure sensor e 21, pressure sensor f 26, gas flow sensor 29, electronic balance 32 and temperature sensor 36. The data analysis unit 38 is a controller and a display, an input end of the controller is respectively electrically connected to the pressure sensor a 9, pressure sensor b 10, pressure sensor c 17, pressure sensor d 19, pressure sensor e 21, pressure sensor f 26, gas flow sensor 29, electronic balance 32 and temperature sensor 36, and an output end of the controller is electrically connected to the display.

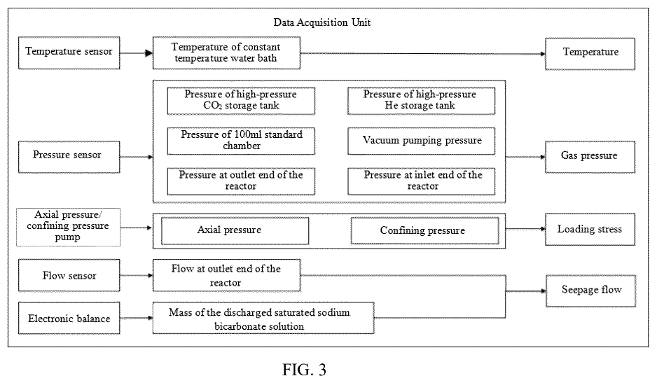

As shown in FIG. 3, the data types of the data acquisition unit 39 include gas pressure, loading stress, temperature and seepage flow. The gas pressure includes the pressure of the high-pressure CO₂ storage tank, the pressure of the high-pressure He storage tank, the pressure of the standard chamber, the pressure at an inlet end of the reactor, the pressure at an outlet end of the reactor, and the vacuum pumping pressure. The loading stress specifically includes axial pressure and confining pressure. The temperature is the temperature of the constant temperature water bath. The seepage flow includes the gas flow at the outlet end of the reactor and the mass of the discharged saturated sodium bicarbonate solution.

A method for testing the full-process negative carbon content of carbon dioxide sequestration in filling bodies based on the above-mentioned device for testing the full-process negative carbon content of carbon dioxide sequestration in filling bodies, the steps are as follows:
step 1: put the filling body sample 48 into the reactor and connect the device for testing the full-process negative carbon content of carbon dioxide sequestration in filling bodies;
step 2: close all valves, open valve b 4, valve d 12, booster pump b 8 and air compressor b 7, inject He into the high-pressure He storage tank 14; after reaching the preset gas pressure (16 MPa in this embodiment), close valve b 4, booster pump b 8 and air compressor b 7, open valve e 16 to inject He into the standard chamber 15, then open valve f 18 to perform air tightness test of the device; if the change in the reading of pressure sensor d 19 is less than 0.002 MPa within 2 hours, it indicates that the device has good air tightness;
step 3: close all valves, open valve e 16, valve f 18, valve g 22 and valve h 23, open the vacuum pump 27 to establish a vacuum in the device; when the reading of pressure sensor f 26 becomes 0, close the vacuum pump;
step 4: set the temperature of the constant temperature water bath 37, and apply axial pressure and confining pressure through the triaxial stress loading subsystem. The experimental temperature range is room temperature~100° C., the axial pressure range is 0~20 MPa, and the confining pressure range is 0~20 MPa;
step 5: close all valves, open valve b 4, valve d 12, booster pump b 8 and air compressor b 7, inject He into the high-pressure He storage tank 14. After reaching the preset gas pressure (1~16 MPa), close valve b 4, booster pump b 8 and air compressor b 7, open valve e 16 to inject He into the standard chamber 15; after the reading of pressure sensor c 17 stabilizes at P_{S1}, close valve d 12 and open valve f 18; when the readings of pressure sensor c 17 and pressure sensor d 19 are the same and stabilize at P_{R2}, calculate the free space volume of the device, i.e., the pore volume V_{S} of the filling body in the reactor. The calculation formula is as follows:

$${V}_{R} = ( \frac{{P}_{S 1} {Z}_{R 2}}{{P}_{R 2} {Z}_{S 1}} - 1 ) {V}_{S}$$

Wherein, V_{R} is the volume of the standard chamber, cm³; V_{S} is the pore volume of the filling body in the reactor, cm³; P_{S1} is the initial He pressure in the standard chamber, MPa; P_{R2} is the stable He pressure in the reactor, MPa; Z_{S1} and Z_{R2} are compression factors of initial He in the standard chamber and stable He in the reactor, respectively, obtained by querying the REFPROP physical property database software developed by the National Institute of Standards and Technology (see Table 1 below);

TABLE 1
Compression factors of helium at 0-16 MPa and 20-100° C.

| | | Helium | | Helium | | Helium | | Helium |
|---|---|---|---|---|---|---|---|---|
| Temperature/ | Pressure/ | Compression | Pressure/ | Compression | Pressure/ | Compression | Pressure/ | Compression |
| ° C. | MPa | Factor | MPa | Factor | MPa | Factor | MPa | Factor |
| 20 | 4 | 1.018811 | 8 | 1.037719 | 12 | 1.056682 | 16 | 1.075669 |
| 30 | | 1.018111 | | 1.036321 | | 1.054591 | | 1.072891 |
| 40 | | 1.17457 | | 1.035014 | | 1.052636 | | 1.070292 |
| 50 | | 1.016845 | | 1.033791 | | 1.050804 | | 1.067856 |
| 60 | | 1.046271 | | 1.032643 | | 1.049085 | | 1.065569 |
| 70 | | 1.015731 | | 1.031564 | | 1.047468 | | 1.063419 |
| 80 | | 1.015223 | | 1.030548 | | 1.045946 | | 1.061393 |
| 90 | | 1.014745 | | 1.029591 | | 1.044511 | | 1.059482 |
| 100 | | 1.014293 | | 1.028687 | | 1.043155 | | 1.057676 |

Step 6: close all valves, open valve e 16, valve f 18, valve g 22 and valve h 23, open the vacuum pump 27 to establish a vacuum in the device; when the reading of pressure sensor f 26 becomes 0, close the vacuum pump 27, close valve f 18, valve g 22 and valve h 23, open valve a 3, valve c 11, booster pump a 5 and air compressor a 6 to inject CO₂ into the high-pressure CO₂ storage tank 13; after reaching the preset gas pressure (1~16 MPa), close valve a 3, booster pump a 5 and air compressor a 6, open valve e 16 to inject CO₂ into the standard chamber 15; after the reading of pressure sensor c 17 stabilizes at P_{S3}, close valve c 11 and open valve f 18; when the readings of pressure sensor c 17 and pressure sensor d 19 are the same and stabilize at P_{R4}, calculate the carbon sequestration capacity of the filling body. The formula is as follows:

$${P}_{S 3} {V}_{R} = {Z}_{S 3} {n}_{b 1} RT$$

$${P}_{R 4} ( {V}_{S} + {V}_{R} ) = {Z}_{R 4} {n}_{b 2} RT$$

$${n}_{b} = \frac{{n}_{b 1} - {n}_{b 2}}{M} = \frac{1}{MRT} ( \frac{{P}_{S 3} {V}_{R}}{{Z}_{S 3}} - \frac{{P}_{R 4} ( {V}_{S} + {V}_{R} )}{{Z}_{R 4}} )$$

Wherein, P_{S3} is the initial CO₂ pressure in the standard chamber, MPa; P_{R4} is the stable CO₂ pressure in the reactor, MPa; V_{R} is the volume of the standard chamber, cm³; V_{S} is the pore volume of the filling body in the reactor, cm³; Z_{S3} and Z_{R4} are the compression factors of initial CO₂ in the standard chamber and stable CO₂ in the reactor, respectively, obtained by querying the REFPROP physical property database software developed by the National Institute of Standards and Technology (see Table 2 below); n_{b} is the carbon sequestration capacity per unit mass of the filling body, mmol/g; n_{b1} and n_{b2} are the initial amount of CO₂ in the standard chamber and the amount of CO₂ in the standard chamber and reactor after the start of sequestration, respectively, mmol; M is the mass of the filling body, g; R is the universal gas constant, 8.31 J/(mol K); T is the temperature of the constant temperature water bath, K;

TABLE 2
Compression factors of carbon dioxide at 0-16 MPa and 20-100° C.

| | | CO₂ | | CO₂ | | CO₂ | | CO₂ |
|---|---|---|---|---|---|---|---|---|
| Temperature/ | Pressure/ | Compression | Pressure/ | Compression | Pressure/ | Compression | Pressure/ | Compression |
| ° C. | MPa | Factor | MPa | Factor | MPa | Factor | MPa | Factor |
| 20 | 4 | 0.740825 | 8 | 0.174515 | 12 | 0.246752 | 16 | 0.316992 |
| 30 | | 0.778099 | | 0.199058 | | 0.259017 | | 0.325936 |
| 40 | | 0.807227 | | 0.486593 | | 0.282593 | | 0.340225 |
| 50 | | 0.830852 | | 0.597849 | | 0.336163 | | 0.362943 |
| 60 | | 0.850479 | | 0.663306 | | 0.438873 | | 0.39876 |
| 70 | | 0.867064 | | 0.710745 | | 0.535212 | | 0.450571 |
| 80 | | 0.881260 | | 0.74784 | | 0.606125 | | 0.511941 |
| 90 | | 0.893535 | | 0.77804 | | 0.660156 | | 0.571581 |
| 100 | | 0.904240 | | 0.803257 | | 0.703177 | | 0.624049 |

step 7: when the CO₂ injection time reaches the target number of days (1~7 days), close valve e 16 and valve f 18, and calculate the free sequestration capacity of the filling body according to the reading P_{R5} of pressure sensor d 19. The calculation formula is as follows:

$${n}_{f} = \frac{{P}_{R 5} {V}_{S}}{{MRTZ}_{R 5}}$$

Wherein, n_{f} is the free sequestration capacity of the filling body, mmol/g; P_{R5} is the pressure in the reactor, MPa; V_{S} is the pore volume of the filling body in the reactor, cm³; Z_{R5} is the compression factor of CO₂ in the reactor, obtained by querying the REFPROP physical property database software developed by the National Institute of Standards and Technology (see Table 2 above); M is the mass of the filling body, g; R is the universal gas constant, 8.31 J/(mol K); T is the temperature of the constant temperature water bath, K.

Further, as a preferred embodiment of the invention, the method also includes a permeability test, and the specific steps are as follows:
step 1: put the filling body sample 48 into the reactor and connect the device for testing the full-process negative carbon content of carbon dioxide sequestration in filling bodies;
step 2: close all valves, open valve b 4, valve d 12, booster pump b 8 and air compressor b 7, inject He into the high-pressure He storage tank 14; after reaching the preset gas pressure (16 MPa in this embodiment), close valve b 4, booster pump b 8 and air compressor b 7, open valve e 16 to inject He into the standard chamber 15, then open valve f 18 to perform air tightness test of the device. If the change in the reading of pressure sensor d 19 is less than 0.002 MPa within 2 hours, it indicates that the device has good air tightness;
step 3: close all valves, open valve e 16, valve f 18, valve g 22 and valve h 23, open the vacuum pump 27 to establish a vacuum in the device; when the reading of pressure sensor f 26 becomes 0, close the vacuum pump;
step 4: set the temperature of the constant temperature water bath 37, and apply axial pressure and confining pressure through the triaxial stress loading subsystem; the experimental temperature range is room temperature~100° C., the axial pressure range is 0~20 MPa, and the confining pressure range is 0~20 MPa;
step 5: close all valves, open valve b 4, valve d 12, booster pump b 8 and air compressor b 7, inject He into the high-pressure He storage tank 14; after reaching the preset gas pressure (1~16 MPa), close valve b 4, booster pump b 8 and air compressor b 7, open valve e 16 to inject He into the standard chamber 15; after the reading of pressure sensor c 17 stabilizes at P_{S1}, close valve d 12 and open valve f 18; when the readings of pressure sensor c 17 and pressure sensor d 19 are the same and stabilize at P_{R2}, calculate the free space volume of the device, i.e., the pore volume V_{S} of the filling body in the reactor. The calculation formula is as follows:

$${V}_{R} = ( \frac{{P}_{S 1} {Z}_{R 2}}{{P}_{R 2} {Z}_{S 1}} - 1 ) {V}_{S}$$

Wherein, V_{R} is the volume of the standard chamber, cm³; V_{S} is the pore volume of the filling body in the reactor, cm³; P_{S1} is the initial He pressure in the standard chamber, MPa; P_{R2} is the stable He pressure in the reactor, MPa; Z_{S1} and Z_{R2} are the compression factors of initial He in the standard chamber and stable He in the reactor, respectively, obtained by querying the REFPROP physical property database software developed by the National Institute of Standards and Technology (see Table 1);
step 6: close all valves, open valve e 16, valve f 18, valve g 22 and valve h 23, open the vacuum pump 27 to establish a vacuum in the device. When the reading of pressure sensor f 26 becomes 0, close the vacuum pump 27; close valve f 18, valve g 22 and valve h 23, open valve a 3, valve c 11, booster pump a 5 and air compressor a 6 to inject CO₂ into the high-pressure CO₂ storage tank 13. After reaching the preset gas pressure (1~16 MPa), close valve a 3, booster pump a 5 and air compressor a 6, open valve e 16 to inject CO₂ into the standard chamber 15. After the reading of pressure sensor c 17 stabilizes at P_{R6}, close valve c 11, open valve f 18 and valve j 28 and start timing. When the readings of pressure sensor c 17 and pressure sensor d 19 are the same and stabilize at P_{R7}, stop timing, record the seepage time as T, read the reading P_{R8} of pressure sensor e 21, monitor the readings of gas flow sensor 29 and electronic balance 32, and calculate the CO₂ permeability in the filling body. The calculation formula is:

$$k = \frac{4 μ QL ( {P}_{R 6} - {P}_{R 7} )}{AT [ {( {P}_{R 6} - {P}_{R 7} )}^{2} - 4 {P}_{R 8}^{2} ]}$$

Wherein, k is the CO₂ permeability; is the dynamic viscosity of CO₂, Pa·s, which can be obtained by querying the REFPROP physical property database software developed by the National Institute of Standards and Technology (see Table 3); Q is the total CO₂ seepage flow, m³; L is the length of the filling body, m; A is the cross-sectional area of the port of the filling body, m²; T is the seepage time, s; P_{R6}, P_{R7} and P_{R8} are the initial pressure at the inlet end of the reactor, the final pressure at the inlet end of the reactor, and the final pressure at the outlet end of the reactor, respectively, MPa.

TABLE 3
Dynamic viscosity of carbon dioxide at 0-16 MPa and 20-100° C.

| | | CO₂ Dynamic | | CO₂ Dynamic | | CO₂ Dynamic | | CO₂ Dynamic |
|---|---|---|---|---|---|---|---|---|
| Temperature/ | Pressure/ | Viscosity | Pressure/ | Viscosity | Pressure/ | Viscosity | Pressure/ | Viscosity |
| ° C. | MPa | (Pa · s) | MPa | (Pa · s) | MPa | (Pa · s) | MPa | (Pa · s) |
| 20 | 4 | 1.58E−05 | 8 | 7.57E−05 | 12 | 8.63E−05 | 16 | 9.44E−05 |
| 30 | | 1.61E−05 | | 5.61E−05 | | 7.24E−05 | | 8.17E−05 |
| 40 | | 1.65E−05 | | 2.23E−05 | | 5.85E−05 | | 7.02E−05 |
| 30 | | 1.69E−05 | | 2.05E−05 | | 4.38E−05 | | 5.95E−05 |
| 60 | | 1.73E−05 | | 2E−05 | | 3.2E−05 | | 4.96E−05 |
| 70 | | 1.77E−05 | | 2E−05 | | 2.71E−05 | | 4.13E−05 |
| 80 | | 1.82E−05 | | 2E−05 | | 2.51E−05 | | 3.54E−05 |
| 90 | | 1.86E−05 | | 2.02E−05 | | 2.41E−05 | | 3.17E−05 |
| 100 | | 1.90E−05 | | 2.05E−05 | | 2.37E−05 | | 2.95E−05 |

Further, as a preferred embodiment of the invention, when the seepage flow is less than or equal to 0.001 m³/min, the gas flow sensor 29 is used to calculate the total CO₂ seepage flow Q; when the seepage flow is greater than 0.001 m³/min, the water displacement method is used to calculate the total CO₂ seepage flow Q through the electronic balance 32.

Finally, it should be noted that the above embodiments are only used to illustrate the technical solutions of the invention and not to limit them; although the invention has been described in detail with reference to the foregoing embodiments, those of ordinary skill in the art should understand that they can still modify the technical solutions recorded in the foregoing embodiments, or equivalently replace some or all of the technical features therein; and these modifications or replacements do not make the essence of the corresponding technical solutions deviate from the scope of the technical solutions of the embodiments of the invention.

1. A method for testing the full-process negative carbon content of carbon dioxide sequestration in filling bodies, including a permeability test of the filling bodies, and the specific steps are as follows:
step 1: put a filling body sample into a reactor and connect the device for testing the full-process negative carbon content of carbon dioxide sequestration in filling bodies;
step 2: close all valves, open a valve d and a valve e, inject He into a standard chamber, then open a valve f to perform air tightness test of the device;
step 3: close all valves, open the valve e and valve f, open a vacuum pump to establish a vacuum in the device;
step 4: set the temperature of a constant temperature water bath, and apply axial pressure and confining pressure through a triaxial stress loading subsystem;
step 5: close all valves, open the valve d and valve e, inject He into the standard chamber, close the valve d, after the reading of the pressure sensor c stabilizes at P_{S1}, open valve f; when the readings of the pressure sensor c and pressure sensor d are the same and stabilize at P_{R2}, calculate the free space volume of the device, i.e., the pore volume V_{S} of the filling body in the reactor; the calculation formula is as follows:
$${V}_{R} = ( \frac{{P}_{S 1} {Z}_{R 2}}{{P}_{R 2} {Z}_{S 1}} - 1 ) {V}_{S}$$
wherein, V_{R} is the volume of the standard chamber, cm³; V_{S} is the pore volume of the filling body in the reactor, cm³; P_{S1} is the initial He pressure in the standard chamber, MPa; P_{R2} is the stable He pressure in the reactor, MPa; Z_{S1} and Z_{R2} are the compression factors of initial He in the standard chamber and stable He in the reactor, respectively, obtained by querying the REFPROP physical property database software developed by the National Institute of Standards and Technology;
step 6: close all valves, open the valve e, valve f, and valve g, open the vacuum pump to establish a vacuum in the device; close the valve f and valve g, open the valve c; inject CO₂ into the standard chamber; close the valve c, after the reading of pressure sensor c stabilizes at P_{R6}, open valve f and valve j and start timing; when the readings of pressure sensor c and pressure sensor d are the same and stabilize at P_{R7}, stop timing, record the seepage time as T, read the reading P_{R8} of pressure sensor e, monitor readings of a gas flow sensor and an electronic balance, and calculate the CO₂ permeability in the filling body; the calculation formula is:
$$k = \frac{4 μ QL ( {P}_{R 6} - {P}_{R 7} )}{AT [ {( {P}_{R 6} - {P}_{R 7} )}^{2} - 4 {P}_{R 8}^{2} ]}$$
wherein, k is the CO₂ permeability; is the dynamic viscosity of CO₂, Pa·s, Q is the total CO₂ seepage flow, m³; L is the length of the filling body, m; A is the cross-sectional area of the port of the filling body, m²; T is the seepage time, s; P_{R6}, P_{R7} and P_{R8} are the initial pressure at the inlet end of the reactor, the final pressure at the inlet end of the reactor, and the final pressure at the outlet end of the reactor, respectively, MPa.

2. The method for testing the full-process negative carbon content of carbon dioxide sequestration in filling bodies according to claim 1, wherein when the seepage flow is less than or equal to 0.001 m³/min, the gas flow sensor is used to calculate the total CO₂ seepage flow Q; when the seepage flow is greater than 0.001 m³/min, the water displacement method is used to calculate the total CO₂ seepage flow Q through the electronic balance.
